(19) United States
(12) Patent Application Publication
(10) Pub. No.: US 2025/0013114 A1
(43) Pub. Date: Jan. 9, 2025

(54) MIXTURE INCLUDING FERROELECTRIC NEMATIC PHASE AND METHODS OF FORMING AND USING SAME

(71) Applicant: The Regents of the University of Colorado, a Body Corporate, Boulder, CO (US)

(72) Inventors: Matthew A. GLASER, Boulder, CO (US); Noel A. CLARK, Boulder, CO (US); Joseph E. MACLENNAN, Boulder, CO (US); Xi CHEN, Boulder, CO (US)

(21) Appl. No.: 18/709,353

(22) PCT Filed: Nov. 10, 2022
(86) PCT No.: PCT/US2022/049620

§ 371 Date: May 10, 2024

Related U.S. Application Data
(60) Provisional application No. 63/278,047, filed on Nov. 10, 2021.

(51) Int. Cl. G02F 1/141; G02F 1/1337

(52) U.S. Cl. CPC G02F 1/141; G02F 1/133723

(57) ABSTRACT

Devices including a volume containing a ferroelectric nematic liquid crystalline material, a dielectric layer overlying a portion of the volume, and a charge-bearing substrate or layer are disclosed. Methods of forming and using such devices are also disclosed.

### CROSS-REFERENCE TO RELATED APPLICATIONS

This application claims the benefit of U.S. Provisional Application Ser. No. 63/278,047, filed on Nov. 10, 2021, and entitled CHARGE-CONTROLLED DEVICES AND METHODS OF FORMING AND USING SAME, the contents of which are hereby incorporated herein by reference to the extent such contents do not conflict with the present disclosure.

### FEDERALLY-SPONSORED RESEARCH

This invention was made with government support under grant number DMR1710711, awarded by the National Science Foundation. The government has certain rights in the invention.

### FIELD OF THE DISCLOSURE

The present disclosure generally relates to devices including a ferroelectric nematic liquid crystalline material and to methods of controlling molecular orientation of a ferroelectric nematic liquid crystal within a volume.

### BACKGROUND OF THE DISCLOSURE

Nematic liquid crystals are materials of anisotropically shaped molecules or particles, which, when packed together in a condensed phase, can achieve a uniform mutual orientation. For example, rod shaped molecules can orient with their long axes tending to be locally aligned along a common direction. This orientational ordering has the beneficial effects of making the material optically anisotropic (birefringent) and of enhancing a response to the application of external influences, such as electric or magnetic fields. Such responsive liquid crystals may be widely useful in a variety of applications. Nematic liquid crystals can be liquid, viscoelastic, or glassy, and made of molecular species that are monomeric, oligomeric, or polymeric. For purposes of this disclosure, we will refer to these various partially fluid-like, partially solid-like liquid crystal materials types as “nematic” and “fluid.”

In addition to their steric rod shape (e.g., like a hot dog), molecules making nematic liquid crystal phases may be polar, with one end differing from the other (e.g., like a baseball bat or an arrow). Molecular polarity can be introduced by, for example, adopting an internal molecular structure that is “dipolar,” in which the internal electrical charge distribution inside the molecule is not spatially uniform, but rather has separated regions of excess positive or negative charge (dipoles). Molecules with dipoles have the possibility of the additional kind of ordering in which the molecular arrows come to point in the same direction (polar ordering). For example, rod-shaped molecules with the dipole arrow along their long axis can spontaneously order parallel and with the dipoles all in the same direction, like the arrows in a quiver or those stuck in a target. If such ordering occurs in a nematic liquid crystal, then resulting material can be said to be optimally “ferroelectric.”

Ferroelectric fluids are interesting because, according to recent modeling, having an optimally common orientation of the dipoles ought to make the response of the fluid to an applied electric field much greater than that of a fluid without the polar ordering; for example, molecules should change their orientation in response to applied voltage at much lower voltages.

Any discussion, including discussion of problems and solutions, set forth in this section has been included in this disclosure solely for the purpose of providing a context for the present disclosure. Such discussion should not be taken as an admission that any or all of the information was known at the time the invention was made or otherwise constitutes prior art.

### SUMMARY OF THE DISCLOSURE

This summary is provided to introduce a selection of concepts. This summary is not intended to necessarily identify key features or essential features of the claimed subject matter, nor is it intended to be used to limit the scope of the claimed subject matter.

Various embodiments of the present disclosure relate to devices, including a volume containing a ferroelectric nematic liquid crystalline material, one or more dielectric layers, and one or more charge-bearing substrates, and to methods of forming and using the same. Exemplary embodiments further relate to sensors, actuators, and the like that include such devices and to methods of using the same.

In accordance with examples of the disclosure, a device includes a volume containing a ferroelectric nematic liquid crystalline material, a dielectric layer overlying at least a portion of the volume, and a charge-bearing substrate overlying at least a portion of the dielectric layer. The volume comprises a polarization charge proximate the dielectric layer that is controllable by a charge on and/or applied to the charge-bearing substrate. In some cases, the device can include one or more additional dielectric layers overlying the volume. In such cases, the device can include one or more additional charge-bearing substrates overlying the one or more additional dielectric layers. Various examples of dielectric layer materials and charge-bearing substrate materials are set forth below.

In accordance with further examples, a sensor, actuator, electro-optic, photonic, nonlinear optical device, ferroelectric memory device, or bifunctional information storage and information processing device is formed using or includes a device as described herein. In accordance with yet further examples, a method of controlling molecular orientation of a ferroelectric nematic liquid crystal within a volume containing said ferroelectric nematic liquid crystal by forming and/or varying a charge on one or more surfaces that at least partially bound said volume to thereby form a polarization charge within the volume and proximate the one or more surfaces is provided.

These and other embodiments will become readily apparent to those skilled in the art from the following detailed description of certain embodiments having reference to the attached figures. The invention is not limited to any particular embodiments disclosed.

### BRIEF DESCRIPTION OF DRAWINGS

A more complete understanding of the embodiments of the present disclosure may be derived by referring to the detailed description and claims when considered in connection with the following illustrative figures.

FIG. 1 illustrates (A) geometry of a planar-aligned N_{F} cell (device) of area A that exhibits charge-controlled block polarization response to an applied voltage; (B) cross-section of the cell, showing the LC and dielectric layers, electrodes, N_{F} polarization P, polarization orientation ψ, free charge, and polarization charge (P); and (C) electrical equivalent circuit of the cell in accordance with examples of the disclosure.

FIG. 2 illustrates a ferroelectric nematic liquid crystal electro-optic cell (device) with in-plane electrodes in accordance with examples of the disclosure.

FIG. 3 illustrates a schematic of a capacitively-controlled dynamic diffraction grating device in accordance with the present disclosure.

FIG. 4 illustrates top views of a simulated charge-controlled Pancharatnam phase device in accordance with examples of the disclosure.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

In this disclosure, any two numbers of a variable can constitute a workable range of the variable, and any ranges indicated may include or exclude the endpoints. Additionally, any values of variables indicated (regardless of whether they are indicated with “about” or not) may refer to precise values or approximate values and include equivalents, and may refer to average, median, representative, majority, the value±10% (e.g., vol. at. or mass %), or the like. Further, in this disclosure, the terms “including,” “constituted by” and “having” or similar words can refer independently to “typically or broadly comprising,” “comprising,” “consisting essentially of,” or “consisting of” in some embodiments. In this disclosure, any defined meanings do not necessarily exclude ordinary and customary meanings.

Further, in some embodiments, layer refers to a structure having a certain thickness formed on a surface or a synonym of film or a non-film structure. A layer can be continuous or noncontinuous. A film or layer may be constituted by a discrete single film or layer having certain characteristics or multiple films or layers, and a boundary between adjacent films or layers may or may not be clear and may or may not be established based on physical, chemical, and/or any other characteristics, formation processes or sequences, and/or functions or purposes of the adjacent films or layers. In some cases, a substrate can refer to a film that is deposited or otherwise on another material.

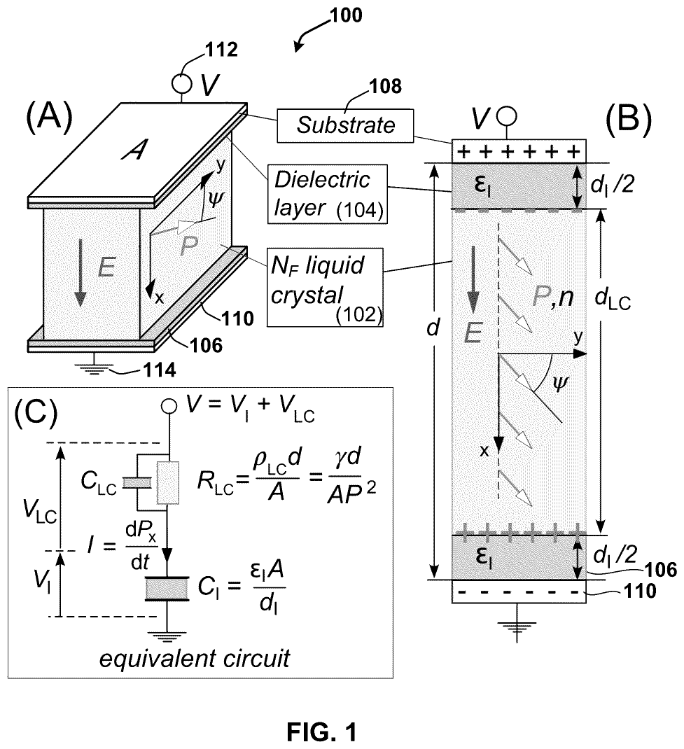

Turning now to the figures, FIG. 1 illustrates a device 100 in accordance with examples of the disclosure. Device 100 includes a volume 102 containing a ferroelectric nematic liquid crystalline material and the surfaces that bound said volume, in which the orientation of molecules in said ferroelectric nematic material is controlled by varying the charge on said bounding surfaces. Device 100 further includes one or more dielectric layers 104, 106 and one or more charge-bearing substrates 108, 110. Device 100 can also include a charge or bias source 112 and a ground connection 114.

In accordance with examples of the disclosure, a surface bounding volume 102 of ferroelectric nematic material is a capacitive interface comprising a dielectric layer (e.g., dielectric layer 104 or 106) between an outer surface of the ferroelectric nematic liquid crystal and an inner surface of a substrate, such as charge-bearing substrate 108 or 110. This interface forms part of a capacitor in which a bound polarization surface charge on the inner (liquid crystal/volume 102) side of the capacitor is controlled by a charge placed on the outer (substrate) side of the capacitor—e.g., using charge source 112. As a result, an orientation of molecules in the ferroelectric nematic volume 102 on the inner side of the capacitor is controlled by the charge placed on the outer side of the capacitor, because the polarization surface charge density at the surface of the ferroelectric nematic depends on the polar molecular orientation at that surface.

As shown in FIG. 1, so-called “V-shaped” or “block polarization” switching can be understood as a charge- or capacitance-controlled process, in which the polarization field of the ferroelectric liquid crystal reorients uniformly (as a “block”) under an applied voltage, with the orientation ψ of the polarization vector relative to the normal to the bounding surfaces governed by the capacitance of the dielectric (e.g., insulating) layers on the electrode surfaces through the relationship ψ(V)=cos⁻¹(C_{I}V/PA), where V is the applied voltage, C_{I} is the capacitance of the dielectric layers (interfacial capacitance), P is the magnitude of the ferroelectric polarization density, and A is the area of the sandwich cell. This can be regarded as a charge compensation effect, in which the orientation ψ is determined by the condition that the polarization surface charge density at the liquid crystal-insulator interface be equal in magnitude and opposite in sign to the free charge density at the neighboring insulator-electrode interface, yielding an analog response that depends on the applied voltage and on the capacitance of the dielectric layers. If dielectric layers 104, 106 are insulating (i.e., have low conductivity), then the polarization field of the ferroelectric material can be “latched” into a specific orientation that is maintained over long timescales under open circuit conditions following the deposition of a prescribed surface charge density on the electrodes. Such devices can therefore function both as optical processing elements and as continuously multistable memory elements, with potential applications in neuromorphic computing. Multistability may additionally lead to reduced power consumption in ferroelectric nematic-based devices.

The mode of operation of these devices is qualitatively distinct from that of devices based on conventional nematic liquid crystals. In conventional nematic devices, free charge placed on electrodes adjacent to the nematic material generates an electric field in the volume of the nematic liquid crystal that couples to the dielectric anisotropy of the nematic material within that volume, producing a torque that reorients the nematic liquid crystal. In contrast, high-polarization ferroelectric nematic liquid crystals exhibit two distinct regimes: for small applied voltages, the response is charge-controlled, with uniform molecular reorientation in the bulk (“block polarization response”) driven by electrostatically-controlled molecular reorientation at the surface. In this electrostatic energy-dominated limit, in which the molecular orientation at the surface produces a polarization surface charge that screens the free charge placed on the electrodes, the electric field is largely confined to the capacitive interface and the field within the volume of the liquid crystal is small, up to a threshold charge density equal to the ferroelectric polarization density of the material. In a high-voltage regime, and during dynamic switching, an electric field appears within the volume of the ferroelectric nematic that couples to the ferroelectric polarization density within that volume, producing a torque that reorients the ferroelectric nematic liquid crystal until the free charge on the electrodes is fully screened. This linear ferroelectric coupling can produce an electro-optic response that is 2-3 orders of magnitude faster than that of conventional nematic devices under comparable applied voltages. See WO 2021/178587, the contents of which are hereby incorporated herein by reference, to the extent such contents do not conflict with the present disclosure.

With continued reference to FIG. 1, FIG. 1 (A) illustrates geometry of a planar-aligned N_{F} cell of area A that exhibits charge-controlled block polarization response to an applied voltage. FIG. 1 (B) illustrates cross-section of the cell, showing the LC and dielectric layers 104, 106, charge-bearing substrates 108, 110 (e.g., electrodes), N_{F} polarization P, polarization orientation ψ, free charge, and polarization charge (P). In the limit of large polarization P=|P|, electrostatic self-screening causes the polarization field to be uniform, with polarization charge expelled to the LC surfaces. When the applied voltage |V|<Vₛₐₜ=2d_{I}P/ε_{I}, the polarization P reorients as a homogeneous block to exclude the electric field from the liquid crystal. FIG. 1 (C) illustrates electrical equivalent circuit of the cell. In the illustrated example, N_{F} volume 102 behaves electrically like a resistor with a resistivity ρ_{LC}=γ/P². This layer is in series with the dielectric, interfacial layers of capacitance C_{I}. C_{LC} represents the “bare” capacitance of the N_{F}, coming from its dielectric response in the absence of the effects due to P. If d_{LC}>>d_{I}, then C_{LC}<<C_{I}, in which case C_{LC} makes a negligible contribution to the electric field response.

Charge-controlled ferroelectric nematic devices, such as device 100, may be static, with a time-independent polarization field imposed by a fixed charge distribution on the bounding surfaces, or dynamic, with a time-varying polarization field that responds to a time-varying charge distribution on the bounding surfaces (e.g., in electro-optic devices). A dynamic charge distribution may be realized with capacitive interfaces that are conductive as well as dielectric, or in photoresponsive devices in which a dynamic charge distribution is generated by photoconductive substrates or dielectric layers.

Charge-controlled ferroelectric nematic devices, such as device 100, may comprise a wide variety of geometries and materials, and may employ diverse methods for depositing charge on bounding surfaces. The bounding substrates (e.g., charge-bearing substrates 108, 110) and/or other substrates and/or dielectric layers may be crystalline or glassy solids, fluids, or soft materials, such as polymers, gels, or emulsions.

Volume 102 can include molecules having one or more electric dipoles. Exemplary molecules for volume 102 can include, for example, (1) a rod shape suitable for nematic liquid crystal ordering; (2) a substantial molecular net dipole parallel to the molecular long axis, said dipole stabilizing head-to-tail chaining of said rod-shaped molecules; (3) molecular subcomponents along the molecular length giving localized charges distributed along the molecular long axis, said charges interacting with opposite charges; (4) minimal flexible tails to enable dipolar charges to interact, but provide enough flexibility to suppress crystallization; and/or (5) lateral groups to control the relative positions along the director of side-by-side molecules, to promote their polar order. By way of example, the molecules can include 4-[(4-nitrophenoxy) carbonyl]phenyl2,4-dimethoxybenzoate, a rod-shaped molecule with a large electrical dipole moment parallel to its long axis. A thickness of volume 102 can range from about 10 nm to about 1 cm or about 2 micrometers to about 100 micrometers.

In accordance with examples of the disclosure, the dielectric layer 104, 106 can be or include an insulator, a layer of finite conductivity, a semiconductor, a self-assembled monolayer, an insulating oxide layer, a photoconductor, or a semiconducting depletion layer. For example, dielectric layer 104, 106 can be or include an oxide layer or other dielectric layer on a conductive (e.g., metallic) charge-bearing substrate (electrode (e.g., aluminum)), a self-assembled monolayer on a metallic electrode (e.g., gold), a semiconducting depletion layer, an electrolyte, or the like. The dielectric layer may additionally or alternatively be intrinsic to the ferroelectric nematic material, comprising a thin surface layer within which the polarization is fixed in orientation by surface interactions. A thickness of dielectric layer 104, 106 can vary from, for example, about 0.1 nm to about 10 micrometers or about 1 nm to about 30 nm.

In some cases, the dielectric layer comprises an alignment layer that orients ferroelectric nematic molecules near the surface. In some cases, each surface bounding said ferroelectric nematic liquid crystal comprises a dielectric layer adjacent to the liquid crystal and a proximate charge-bearing substrate, each surface having finite capacitance and hence acting as a capacitor.

In accordance with additional examples, the charge-bearing substrate 108, 110 may be a (e.g., solid) conductor, semiconductor, or insulator, a solid or liquid electrolyte, an ionic liquid, or the like.

Devices in which the charge density on bounding surfaces is responsive to external fields or other stimuli, such as external electromagnetic or optical fields, chemical or electrochemical reactions, biomolecular binding events, mechanical strain or shear, and fluid flow can be used as sensors. Biomolecular binding events may be of particular interest for sensor applications. A response to external fields or other stimuli is detected electrically and/or optically.

In accordance with further examples of the disclosure, a surface bounding volume 102 may comprise conductive substrates spatially patterned with regions of varying capacitance, leading to spatially varying, analog response of said ferroelectric nematic material to applied voltages, and enabling a variety of static and dynamic electro-optic and photonic effects. Spatially varying capacitance can be achieved by deposition of dielectric layers of varying thickness and/or dielectric constant on the conductive surfaces that bound volume 102 containing the ferroelectric nematic material. Under applied voltages, capacitive coupling between the charge-bearing substrate (e.g., electrodes) and the ferroelectric nematic material produces a spatially varying, voltage-dependent ferroelectric nematic polarization field within volume 102 containing the ferroelectric nematic material, resulting in spatial variation in the optical and/or electrical properties of the ferroelectric material, including the dielectric constants, refractive indices, and nonlinear optical susceptibilities. This spatially varying, analog, voltage-dependent response is the basis for a wide variety of electro-optic and photonic devices, with potential applications in spatial light modulators, lidar systems, beam steering, adaptive optics, and photonic integrated circuits, to mention a few examples, and may be realized in a variety of device geometries, including thin films of ferroelectric nematic material confined between planar conducting substrates, or waveguide structures containing ferroelectric nematic material. The dielectric layers deposited on the conductive surfaces may additionally serve as alignment layers, providing another means of controlling the ferroelectric nematic molecular orientation and polarization field within the volume containing ferroelectric nematic material.

Examples of the disclosure described here utilize methods for achieving charge control in devices based on high-polarization ferroelectric nematic liquid crystals. Another key new feature is patterning of the (e.g., conductive or dielectric) surfaces that confine a volume of ferroelectric nematic liquid crystalline material to produce a spatially varying capacitance, enabling the creation of complex, high-speed electro-optic devices that utilize simple driving schemes. A further example includes use of spatially patterned electrodes (rather than monolithic electrodes) in addition to spatially patterned dielectric layers to achieve an even higher level of device complexity and functionality.

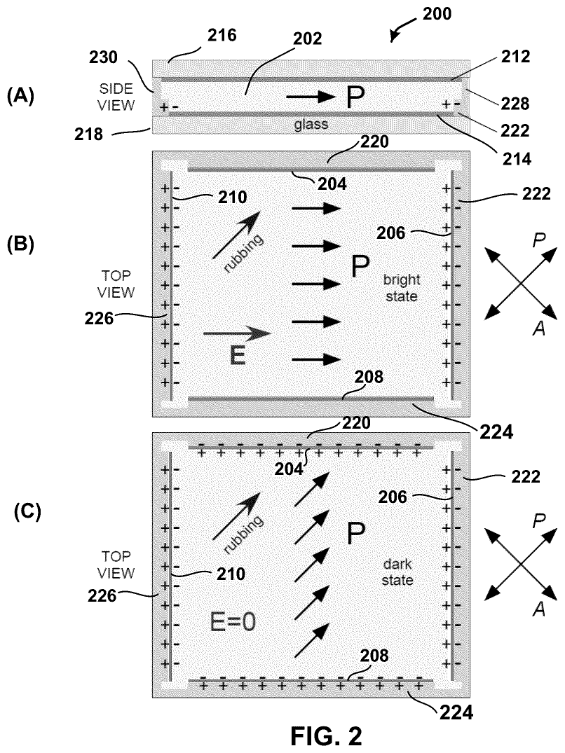

A specific example of a high-speed, charge-controlled device 200 based on ferroelectric nematic liquid crystals is an in-plane switching electro-optic device 200 illustrated in FIG. 2. As illustrated, device 200 can include a volume containing a ferroelectric nematic liquid crystalline material 202, dielectric layers 204-210, alignment layers 212, 214, glass substrates 216, 218, and charge-bearing substrates 220-226. Various components of device 102, such as volume containing a ferroelectric nematic liquid crystalline material 202, dielectric layers 204-210, alignment layers 212, 214 (e.g., formed on a dielectric layer or substrate), and charge-bearing substrates 220-226 can be as described above.

In more detail, FIG. 2 illustrates device 200 with in-plane electrodes/charge-bearing substrates 220-226. Insulating confining walls 228, 230 minimize electrohydrodynamic flow. Alignment layers 212, 214 rubbed at, e.g., 45°, to the electrodes provide polar anchoring on both surfaces, orientationally stabilizing either twisted or uniform director states. Applied voltages produce charges on the electrodes that are compensated by surface charge in the LC. The director (polarization) orientation is controlled by applying appropriate voltages to either or both sets of electrodes.

In the illustrated example, device 200 comprises four in-plane charge-bearing substrates 220-226 (e.g., electrodes) that are used to reorient the LC material within volume 202 in the plane of the cell/device. The surfaces of two bounding glass plates 216, 218 spaced a few microns apart are treated with an alignment layer, such as Glymo or polyimide, as shown in FIG. 2 (A). Polyimide rubbed at 45° to the electrodes, as shown in FIG. 2 (B), induces a small pretilt and provides polar anchoring on both surfaces, stabilizing either twisted or uniform director states in the absence of applied voltage, depending on whether they are rubbed parallel or anti-parallel. The basic configuration, shown in FIG. 2 (B), has four independent (e.g., gold) electrodes (charge-bearing substrates) arranged around the edges of a square or rectangular pixel. By applying appropriate voltages (e.g., using bias source 112) to the electrodes, the polar liquid crystal director (polarization) can be oriented in any desired direction. For example, voltage applied between the East and West electrodes (FIG. 2 (B)) orients the director horizontally, while connecting North to East and South to West (FIG. 2 (C)) results in orientation at 45° to the electrodes along the rubbing direction. Capacitance effects of the electrodes may be controlled by coating the electrodes with a very thin dielectric layer, such as alkane thiol self-assembled monolayer (SAM), before assembling the cell.

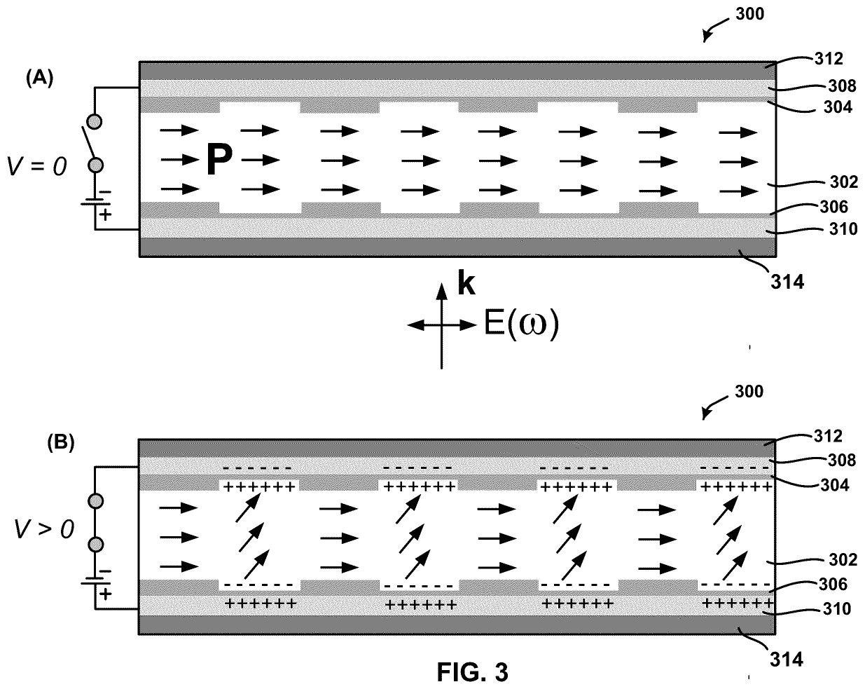

Another example of a charge-controlled device 300 is illustrated in FIG. 3. Device 300 includes a volume containing a ferroelectric nematic liquid crystalline material 302, dielectric layers 304, 306, charge-bearing substrates 308, 310, and glass substrates 312, 314. Such components can be as described above. In the illustrated example, the ferroelectric nematic polarization field is uniform-planar in the absence of an applied voltage FIG. 3 (A) but becomes non-uniform in the presence of an applied voltage FIG. 3 (B), presenting a periodically varying effective refractive index to normally incident electromagnetic radiation. This device is thus non-diffracting in the absence of an applied voltage and acts as a voltage-tunable diffractive element for finite applied voltages. Exemplary applied voltages can be as described elsewhere herein.

Device 300 can be a dynamic diffraction grating that includes a thin layer of ferroelectric nematic material confined between two (e.g., ITO-on-glass) substrates with a pattern of lines of varying capacitance deposited on the two substrates, in which the polar director field of the ferroelectric layer is uniform-planar in the absence of an applied voltage and becomes non-uniform in the presence of an applied voltage, presenting a periodically varying effective refractive index to normally incident electromagnetic radiation E (w) along k, as illustrated in FIG. 3. Device 300 is thus non-diffracting in the absence of an applied voltage and acts as a voltage-tunable diffractive element for finite applied voltages. Exemplary voltages can range from 0.01 to about 100 V or about 1.5 to about 5 V.

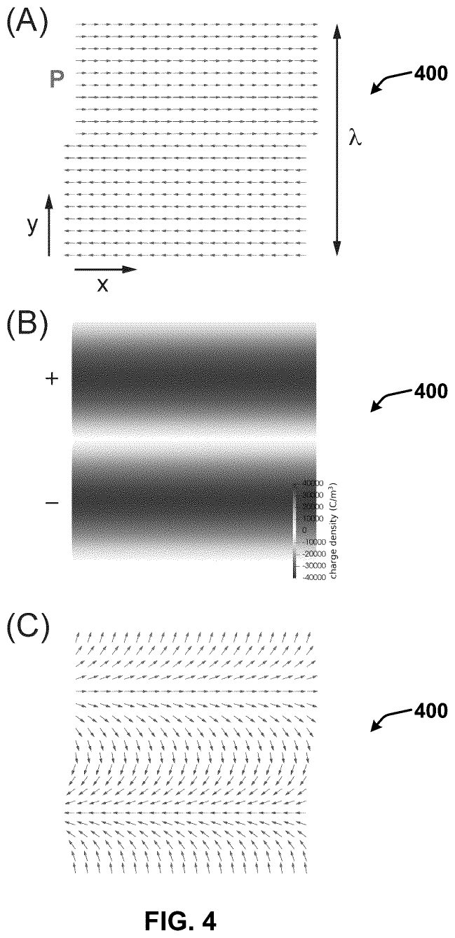

A wide variety of other charge-controlled electro-optic devices are possible. For example, a tunable Pancharatnam phase beam-steering device 400 may be realized with a more complex spatial patterning of the insulating layer and with two sets of electrodes, as illustrated in FIG. 4. Such devices can diffract light into a single diffracted mode with high efficiency, and utilization of ferroelectric nematic materials may lead to high-speed beam steering, on the order of 100 to 1000 times faster than in devices based on conventional nematic materials.

FIG. 4 illustrates top views of a simulated charge-controlled Pancharatnam phase device 400, demonstrating switching of a N_{F} thin film in response to a sinusoidal charge density wave. FIG. 4 (A) illustrates that in the absence of an applied voltage, the polarization field P(y) includes a periodic array of stripes of alternating orientation along the −x and +x directions, with wavevector q_{y}=2π/λ. Such a structure may be achieved by periodically varying, unidirectional buffing of stripes of width λ/2 in an alignment layer adjacent to the N_{F} thin film, with the buffing direction alternating between −x and +x. In the presence of a sinusoidal charge density wave, as illustrated in FIG. 4 (B), the N_{F} polarization field switches into a state in which the orientation of P varies linearly with y, as illustrated in FIG. 4 (C), realizing the continuously varying optical phase delay required for Pancharatnam phase beam-steering devices. In this situation, regions of high charge density induce splay in P, resulting in a periodic splay-bend modulation. A periodic charge density wave may be produced by an applied voltage on an interdigitated electrode array of pitch λ on a substrate adjacent to the N_{F} thin film. For a periodicity of λ=10 μm, our numerical simulations show that switching between the on and off states occurs on a timescale of ˜100 ns.

Another family of exemplary, capacitively controlled ferroelectric nematic liquid crystal devices utilize dynamic photonic bandgap structures. An example of such a device is a waveguide containing ferroelectric nematic material, with the conducting surfaces of the waveguide coated with insulating layers that are patterned to produce a periodically varying capacitance along the length of the waveguide, with period comparable to the wavelength of electromagnetic radiation propagating in the waveguide. In the absence of an applied voltage, incident electromagnetic radiation is transmitted through the waveguide, whereas a finite applied voltage produces a periodic variation of effective refractive index, creating a photonic bandgap that reflects incident electromagnetic radiation with high efficiency (Bragg reflection). Such high-speed, non-absorptive optical switches have potential applications in photonic integrated circuits and optical computers. Elaborations of this basic photonic device include “chirped” spatial variation of capacitance along the length of the waveguide to produce broad-band, voltage-dependent reflection.

Capacitive control of the polarization field of ferroelectric nematic materials may also be utilized in devices that take advantage of the second-order nonlinear optical susceptibility of ferroelectric nematics, for example, for fine-tuning electronic electro-optic modulators based on Mach-Zender interferometers containing ferroelectric nematic materials.

In accordance with additional embodiments, a method of controlling molecular orientation of a ferroelectric nematic liquid crystal within a volume containing said ferroelectric nematic liquid crystal by forming and/or varying a charge on one or more surfaces that at least partially bound said volume to thereby form a polarization charge within the volume and proximate the one or more surfaces is provided. Such methods can be employed in the operation of a device, sensor, actuator, or the like.

The example embodiments of the disclosure described above do not limit the scope of the invention, since these embodiments are merely examples of the embodiments of the invention, which is defined by the appended claims and their legal equivalents. Any equivalent embodiments are intended to be within the scope of this invention. Various modifications of the disclosure, in addition to those shown and described herein, such as alternative useful combinations of the elements described, may become apparent to those skilled in the art from the description. Such modifications and embodiments are also intended to fall within the scope of the appended claims.

1. A device comprising:
a volume containing a ferroelectric nematic liquid crystalline material;
a dielectric layer overlying a portion of the volume; and
a charge-bearing substrate overlying at least a portion of the dielectric layer,
wherein the volume comprises a polarization charge proximate the dielectric layer that is controllable by a charge on and/or applied to the charge-bearing substrate.

2. The device of claim 1, further comprising one or more additional dielectric layers overlying the volume.

3. The device of claim 2, further comprising one or more additional charge-bearing substrates overlying the one or more additional dielectric layers.

4. The device of any of claims 1-3, wherein each surface bounding said ferroelectric nematic liquid crystal comprises a dielectric layer adjacent to the liquid crystal and a proximate charge-bearing substrate, each surface having finite capacitance and hence acting as a capacitor.

5. The device of any of claims 1-4, wherein the polarization charge and molecular orientation of the ferroelectric nematic liquid crystal on the inner (liquid crystal) side of the capacitor is controlled by varying the charge on the outer (substrate) side of the capacitor.

6. The device of any of claims 1-5, wherein the dielectric layer comprises a crystalline or glassy solid.

7. The device of any of claims 1-5, wherein the dielectric layer comprises a fluid.

8. The device of any of claims 1-5, wherein the dielectric layer comprises a soft material, e.g., a polymer, gel, emulsion, surfactant, or liquid crystal.

9. The device of any of claims 1-8, wherein the dielectric layer comprises an insulator.

10. The device of any of claims 1-8, wherein the dielectric layer has finite conductivity.

11. The device of any of claims 1-8, wherein the dielectric layer comprises a semiconductor.

12. The device of any of claims 1-8, wherein the dielectric layer comprises a self-assembled monolayer.

13. The device of any of claims 1-8, wherein the dielectric layer comprises an insulating oxide layer.

14. The device of any of claims 1-8, wherein the dielectric layer comprises a photoconductor.

15. The device of any of claims 1-8, wherein the dielectric layer comprises a semiconducting depletion layer.

16. The device of any of claims 1-8, wherein the dielectric layer comprises a surface layer in the ferroelectric nematic liquid crystal within which the ferroelectric polarization is fixed.

17. The device of any of claims 1-16, wherein the dielectric layer comprises an alignment layer that orients ferroelectric nematic molecules near the surface.

18. The device of any of claims 1-17, wherein the substrate comprises a crystalline or glassy solid.

19. The device of any of claims 1-17, wherein the substrate comprises a fluid.

20. The device of any of claims 1-17, wherein the substrate comprises a soft material, e.g., a polymer, gel, emulsion, surfactant, or liquid crystal.

21. The device of any of claims 1-20, wherein the substrate comprises a conductor.

22. The device of any of claims 1-20, wherein the substrate comprises a semiconductor.

23. The device of any of claims 1-20, wherein the substrate comprises an insulator.

24. The device of any of claims 1-20, wherein the substrate comprises an electrolyte.

25. The device of any of claims 1-20, wherein the substrate comprises an ionic liquid.

26. The device of any of claims 1-25, wherein the charge on the bounding surface and the resulting molecular orientation of the ferroelectric nematic liquid crystal responds to external fields or other stimuli, including external electromagnetic or optical fields, chemical or electrochemical reactions, biomolecular binding events, mechanical strain or shear, and fluid flow.

27. The device according to claim 26, wherein a response to external fields or other stimuli is detected electrically.

28. The device according to claim 26, wherein a response to external fields or other stimuli is detected optically.

29. A sensor comprising a device as in any of claims 1-28.

30. An actuator comprising a device as in any of claims 1-28.

31. The device of any of claims 1-28, wherein the volume comprising a ferroelectric nematic liquid crystal is at least partially bounded by surfaces with spatially varying capacitance, in which said molecular orientation in said ferroelectric nematic material exhibits spatially varying analog response to applied voltages.

32. The device of any of claims 1-28, wherein the volume comprising a ferroelectric nematic liquid crystal is at least partially bounded by surfaces with spatially varying capacitance and with patterned electrodes on the bounding substrates, in which said molecular orientation in said ferroelectric nematic material exhibits spatially varying analog response to voltages applied to said patterned electrodes.

33. An electro-optic, photonic, or nonlinear optical device comprising a device according to any of claim 1-28, 31 or 32.

34. A ferroelectric memory device comprising a device as in claims any of claim 1-28, 31 or 32, with insulating dielectric layers that enable long-term retention of the molecular orientation state of a ferroelectric nematic liquid crystal under open-circuit conditions.

35. A bifunctional information storage and information processing device comprising a device as in any of claim 1-28, 31 or 32.

36. A method of controlling molecular orientation of a ferroelectric nematic liquid crystal within a volume containing said ferroelectric nematic liquid crystal by forming and/or varying a charge on one or more surfaces that at least partially bound said volume to thereby form a polarization charge within the volume and proximate the one or more surfaces.
